(19) United States
(12) Patent Application Publication
(10) Pub. No.: US 2002/0090975 A1
(43) Pub. Date: Jul. 11, 2002

(54) Paging in a mobile telecommunication network

(76) Inventors: Keijo Laiho, Masala (FI); Janne Suotula, Helsinki (FI)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/043,438

(22) Filed: Jan. 10, 2002

(30) Foreign Application Priority Data
Jan. 10, 2001 (GB) 0100659.2

(51) Int. Cl. H04B 1/38

(52) U.S. Cl. 455/552; 455/553; 455/466; 455/458; 455/439; 455/560

(57) ABSTRACT

A method of initiating a call to a multi-mode mobile telecommunication device (2) served by two or more access networks (6, 7) comprises sending a paging signal that specifies a preferred access network to the mobile telecommunication device. This ensures that the call will not be rejected as a consequence of being set up over an access network that cannot support the call. The invention also provides a method of completing a call to a mobile telecommunication device in which a paging response is returned via a first access network (6). It is then determined whether the first access network can support the call. If the first access network cannot support the call, rather than rejecting the call, according to the invention a communication channel is set up to the mobile telecommunication device over another access network (7) that can support the call.

### FIELD OF THE INVENTION

The present invention relates to paging in a mobile telecommunication network and in particular though not necessarily to the paging of a multi-mode mobile telecommunication device. A multi-mode mobile telecommunication device is a mobile telecommunication device that is supported by two or more mobile telecommunication networks.

### BACKGROUND TO THE INVENTION

In a typical digital mobile telecommunication network, BTSs are responsible for communicating with mobile stations within respective geographical cells within which the BTSs are centred. Sets of adjacent BTSs are grouped into respective Location Areas (LA). In the European GSM networks, the BTSs of a given LA are controlled by a Base Station Controller (BSC). A Visitor Location Register (VLR) maintains a record of the mobile stations currently registered with the network, as well as the LA in which each registered mobile station is currently located. This information is updated as mobile stations roam between LAs. Each VLR is typically co-located with a MSC of the network. A mobile station currently registered with a network is notified of an incoming call by a paging message transmitted from a mobile switching centre (MSC) of the network, via a Base Transceiver Station (BTS), on a broadcast paging channel.

In the future, there may exist a number of different mobile telecommunication networks having overlapping geographical coverage. As a result, there may be geographical areas that are served by two or more different mobile telecommunication networks. To take advantage of this, multi-mode mobile telephones such as dual-mode mobile telephones will be required. It will then be possible to place a call to a multi-mode mobile telephone over one of two or more different mobile telephone networks. For example, a second generation GSM network and a third generation UMTS network may overlap in many geographic areas (typically, GSM and UMTS access networks will be provided with both sharing a common core network), and the use of a dual-mode mobile telephone that may communicate with either a GSM BTS or a UMTS BTS will make it possible to provide UMTS and GSM access to the mobile telephone without the need for the mobile telephone to perform roaming between the two different mobile telecommunication access networks. This makes it possible for the telecommunication access network currently supporting a dual-mode mobile telephone to change—that is, the mobile telephone moves from a UMTS cell to a GSM cell within the same LA without the need to make a location update.

### SUMMARY OF THE INVENTION

One problem encountered by such future multi-mode mobile telephones is that different mobile telecommunication access networks are likely to support different services. While all mobile telecommunication access networks support voice telephone calls to a mobile telephone, this is not the case for other services such as, for example, facsimile services. As an example, the proposed UMTS access networks cannot support a group 3 facsimile transmission, although the GSM access network can support a G3 facsimile transmission.

If a calling party attempts to place a G3 facsimile transmission to a dual-mode mobile telecommunication device, such as a UMTS/GSM mobile telephone, an attempt is made to setup a communication channel to the mobile telecommunication device. The success of the attempt will depend upon which access network is currently being used by the device. If an attempt is made to setup a communication channel to the mobile telephone over the GSM access network, the attempt will be successful and the facsimile transmission to the mobile telephone will be completed. This is not the case, however, if the mobile telephone is supported by the UMTS network when the calling party attempts to place the call, as is illustrated with regard to FIG. 1.

FIG. 1 illustrates the process of placing a fax call from a calling party 1 to a dual-mode (UMTS/GSM) mobile telephone handset 2. The mobile telephone handset 2 is in a LA 5 that is supported by a UMTS telecommunication access network 6 and a GSM access network 7. The UMTS telecommunication access network 6 and the GSM network 7 are supported by a Mobile Switching Centre (MSC) 3 of a common core network. The subscriber (handset user) is registered with a Visitor Location Register (not shown in FIG. 1) of the core network which also records the current LA of the subscriber.

In step S1 an initial address message (IAM) for the facsimile call is sent from the local exchange of the calling party 1 to the MSC 3. Upon receipt of the IAM, the MSC 3 sends a paging signal to the mobile telephone 2. In fact, two paging signals are sent to the mobile telephone 2, one over the UMTS access network 6 and one over the GSM access network 7, as step S2.

At step S3, the mobile telephone handset 2 will return a paging response signal. In the example of FIG. 1, it is assumed that at the time of paging, the mobile telephone 2 is “operating” in the UMTS access network 6 and is therefore listening to the UMTS paging channel(s). As the incoming call received from the calling party 1 is a facsimile call, the MSC 3 will determine at this stage that the proposed communication channel to the mobile telephone 2 over the UMTS access network 6 cannot support the call. Accordingly, at step S4 the incoming call is rejected. The incoming facsimile call is rejected even though the mobile telephone handset 2 is within a geographical area that is served by a GSM access network 7 that could have supported the facsimile call. The problem arises because the MSC 3 of the core network does not know which access network the telephone is listening to.

A similar problem arises if there was a pre-existing call to the mobile telephone 2 when the incoming facsimile call is received from the calling party 1. If there was a pre-existing call connected to the mobile telephone when the IAM of the incoming facsimile call was received, the BTS would not transmit paging signals but would rather attempt to establish another communication channel to the mobile telephone 2 over the same access network that was handling the pre-existing call. Thus, if the pre-existing call was connected over the UMTS access network 6 an attempt would be made to connect the incoming facsimile call over the UMTS network; this would not be able to support the facsimile call and the facsimile call would be rejected.

A related problem is that of undesired inter-system handover. When a call to a dual-mode telecommunication device has been set up over one access network, there is a possibility that an automatic transfer of the call to another access network may be initiated, for example in an attempt to even out demand between the two mobile telecommunication access networks or as a result of a change in location of the mobile telecommunication device. If the access network to which the call is to be transferred cannot handle the call, the transfer will be prevented. In the example illustrated in FIG. 1, if the facsimile call had been set up to the mobile telephone 2 over the GSM access network 7, then an attempt to automatically handover of the call from the GSM access network 7 to the UMTS access network 6 will be denied. This process will incur an unnecessary signalling overheads within and between the core network and the access networks.

A first aspect of the present invention provides a method of initiating a connection to a multi-mode mobile telecommunication device, the method comprising the step of sending a paging message to the mobile telecommunication device from a core network, the paging message specifying a preferred mobile telecommunication access network for the connection.

In the situation illustrated in FIG. 1, when the calling party attempts to place a facsimile call to the mobile handset the paging message sent by the BTS indicates that the GSM access network is the preferred access network for the connection (since this network can support facsimile transmissions whereas the UMTS access network cannot). This allows the mobile handset to return a paging response signal over the GSM access network rather than over the UMTS access network, so that the connection could be completed to the mobile handset over the GSM access network.

A second aspect of the present invention provides a paging control system for a multi-mode mobile telecommunication device, the system comprising:

input means for receiving a connection setup message corresponding to an new connection for the multi-mode mobile telecommunication device; and

means for determining from the connection setup message whether there is a preferred mobile telecommunication access network for the new connection.

In the situation of FIG. 1 for example, the paging control system is located at an MSC of a core network and determines from the IAM for the incoming facsimile call that the GSM access network is the preferred access network for the call.

In a preferred embodiment the paging control system further comprises transmission means for causing the transmission of a paging message corresponding to the alert over a paging channel of a telecommunication access network serving the multi-mode mobile telecommunication device, the transmission means being arranged to cause the broadcast of a paging message containing an indication of a preferred mobile telecommunication access network for the connection.

A third aspect of the present invention provides a multi-mode mobile telecommunication device comprising:

means for receiving a paging message initiating a connection, the paging message containing an indication of a preferred mobile telecommunication access network for the connection;

means for determining the preferred mobile telecommunication access network from the paging message; and

means for transmitting a paging response signal over the preferred mobile telecommunication access network.

A fourth aspect of the present invention provides a method of setting up a connection to a multi-mode mobile telecommunication device, the method comprising the steps of:

sending a paging request from a core network to the device via at least one access network;

receiving at the core network a paging response from the device via an access network to whose paging channel(s) the device is currently listening;

determining whether that access network can support the connection; and

if it is determined that the access network to which the device is listening cannot support the connection, establishing a communication channel to the mobile telecommunication device over a second mobile access network that can support the connection.

In the prior art example of FIG. 1, when the communication channel to the telephone 2 is set up over the UMTS access network 6 and it is then determined that a connection is a connection that the UMTS access network cannot support, the connection is rejected. In the method according to the fourth aspect of the present invention, this would not happen. Instead, when it determined that the UMTS access network cannot support the connection, the connection is transferred to another telecommunication access network which is able to support the connection. In the situation of FIG. 1, according to the invention the incoming facsimile call would not be rejected but would be transferred to the GSM access network.

A fifth aspect of the present invention provides a method of completing an incoming or outgoing call to a multi-mode mobile telecommunication device when a pre-existing call is connected to the mobile telecommunication device, the method comprising the step of:

determining whether the mobile telecommunication access network over which the pre-existing call is established can support the new call.

A sixth aspect of the invention provides a method of handling a connection to a multi-mode mobile telecommunication device, the method comprising the steps of:

setting up the connection over a first mobile telecommunication access network that can support the connection;

determining whether a second mobile telecommunication access network can support the connection; and

if it is determined that the second mobile telecommunication access network cannot support the connection, inhibiting handover of the connection to the second mobile telecommunication access network.

The method is preferably implemented at an MSC or SGSN of a core network. In particular, said step of inhibiting a potential handover of the connection to the second mobile telecommunication access network is initiated by the MSC/SGSN, which sends a blocking signal to the RNC/BSC of the current access network.

This aspect of the invention addresses the problem of unwanted handover of a telephone connection from one telecommunication access network to another. In the situation of FIG. 1, once the facsimile call had been set up over the GSM access network, intersystem handover of the call to the UMTS access network would be inhibited according to this aspect of the invention.

Other aspects of the invention provide Mobile Switching Centres and Serving GPRS Support Nodes for carrying out the methods of the invention.

According to a further aspect of the present invention there is provided a method of initiating a connection from a telecommunication system to one of a set of two or more communication devices, the method comprising the step of sending a paging message to at least one of the set of devices from a core network of the system, the paging message specifying a preferred mobile telecommunication access network for the connection.

In the event that the paging message is received by a device which cannot connect to the preferred access network, the connection is established via another of the devices which is able to connect to the preferred network. The other device may be notified of the paging message by the receiving device via a local wireless link, e.g. via a Bluetooth connection.

3GPP is currently considering defining three separate domain types in the core network; a circuit switched domain, a packet switched domain, and a multi-media domain. Calls (or connections) are routed in the circuit switched domain by MSCs, in the packet switched domain by SGSNs, and in the multi-media domain by nodes yet to be defined. According to a still further aspect of the present invention, when it is desired to establish a connection to a device via a specific one of these domains, paging messages may be sent via one or both of the other domains. The paging messages will identify the preferred domain.

### BRIEF DESCRIPTION OF THE DRAWINGS

FIG. 1 is a schematic illustration of a prior art method of initiating a call to a dual-mode mobile telecommunication device;

FIG. 2 is a schematic illustration of a method of initiating a call to a multi-mode mobile telecommunication device according to a first embodiment of the present invention; and

FIG. 3 is a schematic illustration of a method of initiating a call to a multi-mode mobile telecommunication device according to a second embodiment of the present invention.

### DETAILED DESCRIPTION OF PREFERRED EMBODIMENTS

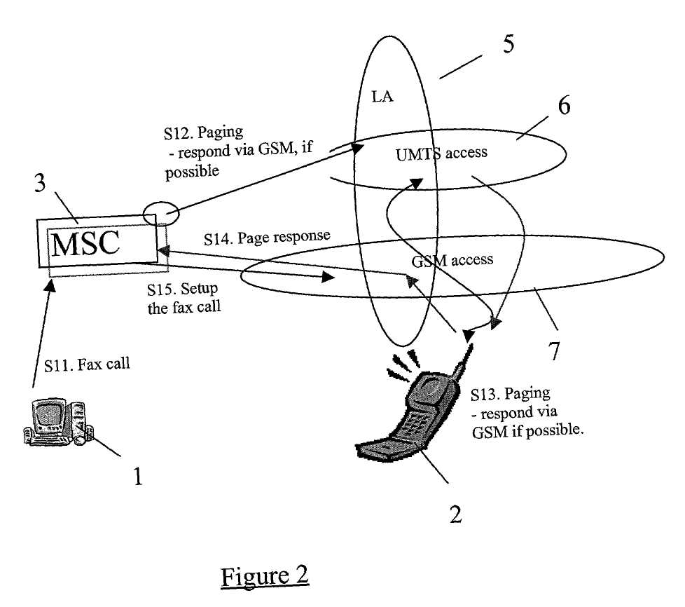

A first embodiment of the present invention will be described with reference to FIG. 2. In this embodiment, the paging signal sent to a multi-mode (GSM/UMTS) mobile telecommunication device contains an indication of the preferred mobile access network for a call. The mobile telecommunication device is then able to return the paging response signal via the preferred access network and set up the call over the preferred access network.

In the embodiment of FIG. 2, a calling party 1 wishes to send a facsimile transmission to a multi-mode mobile telecommunication device 2. In this embodiment the multi-mode mobile telecommunication device is a dual-mode mobile telecommunication device 2. The mobile telecommunication device 2 is shown as a telephone handset, but the invention is not limited to this and could be a mobile communicator, PDA or the like.

The dual-mode telecommunication device 2 is located in a Location Area (LA) 5 that is served by two mobile telecommunication access networks. In the embodiment of FIG. 2 these are a UMTS access network 6 and a GSM access network 7, but the invention is not limited to these particular two networks. A core network containing an MSC 3 supports the telecommunication access networks.

The facsimile transmission is initiated by the calling party 1 dialling the number associated with the mobile telecommunication device 2, and thereby causing an IAM initiating the facsimile call to be sent to the MSC 3 as step S11. The MSC 3 is provided with input means for receiving the IAM, and a transmission means for causing the transmission of a paging message corresponding to the LAM. The MSC 3 is further provided with means for determining the nature of the incoming call—that is, whether the incoming call is a voice telephone call, facsimile call, data call, multi-media call etc. Thus, when the MSC 3 receives an IAM, it determines the type of call to which the IAM relates. In the example of FIG. 2, it would determine that the received IAM relates to a G3 facsimile transmission.

The MSC 3 is further able to determine whether one or other of the telecommunication access networks supporting the mobile telecommunication device 2 is preferred for completing the telephone call. In particular, if only one of the telecommunication access networks is able to support a particular incoming call the MSC 3 will determine that that access network is the preferred network for that call. In the example of FIG. 2, therefore, the MSC 3 determines that the GSM access network is the preferred telecommunication access network for handling the G3 facsimile call. The MSC 3 then sends a paging message to the mobile telecommunication device 2, to inform it of the incoming call. As illustrated in FIG. 2, this paging signal is sent over respective paging channels of the UMTS and GSM access networks 6,7 as step S12. This is necessary because the core network does not know which of the access networks the device 2 is currently listening to. In addition to the information contained in a conventional paging message, the paging message transmitted by the MSC 3 also contains an indication that the GSM network is the preferred network for handling the call.

It is assumed that the mobile device 2 is currently listening to the paging channel(s) of the UMTS access network 6, and therefore receives the new paging message via this network. Upon receipt of a paging message, the mobile telecommunication device 2 makes a determination whether the paging message contains any indication of a preferred access network for the call and, if it does, identifies the preferred network. In the example of FIG. 2, therefore, the mobile telecommunication device 2 would determine, as step S13, that the GSM network 7 was the preferred access network for the call since this is specified in the paging message. The mobile telecommunication device 2 returns a paging response signal to the MSC 3 over the GSM access network 7, as step S14.

Upon receipt of the paging response signal, the MSC 3 carries out an authorisation process, which can be any conventional authorisation process, and if this is satisfactory, returns an Address Complete Message (ACM) to the local exchange of the calling party 1. The facsimile call from the calling party 1 can now be completed to the mobile telecommunication device 2 via the MSC 3 and the GSM network 7, as step S15. Since the GSM network is able to support facsimile calls, the call is not rejected.

In an analogous situation to that described above, a call setup message may be received at a Serving GPRS Support Node (SGSN) of the core network, in which case the paging messages sent over the access networks originate from that SGSN. Again, the paging messages contain the identity of the preferred network.

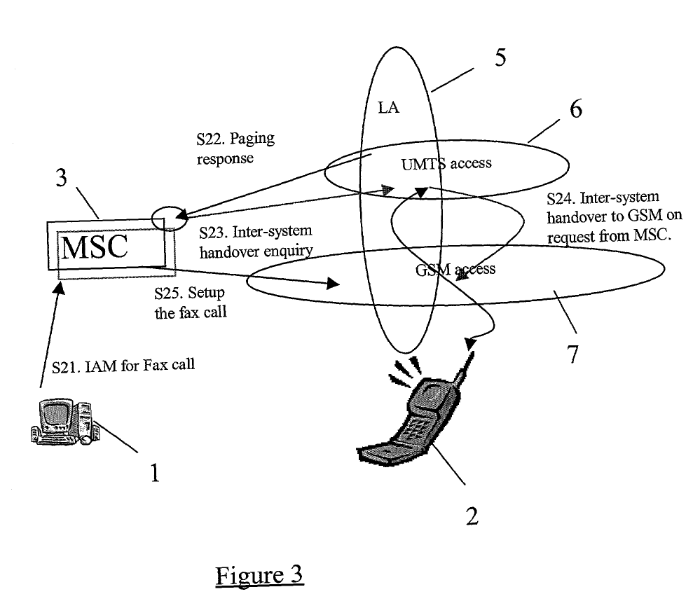

A second embodiment of the present invention will now be described with regard to FIG. 3. FIG. 3 again illustrates a facsimile call being placed from a calling party 1 to a dual-mode mobile telecommunication device 2. The mobile telecommunication device 2 is in a LA 5 that is served by two mobile access networks, in this example a UMTS access network 6 and a GSM access network 7. The mobile telecommunication access networks are controlled by an MSC 3 of a core network.

To initiate a G3 facsimile transmission, the calling party 1 dials the number of the mobile telecommunication device 2, and this causes an LAM to be sent from the local exchange of the calling party 1 to the MSC 3, as step S21. Upon receipt of the IAM, the MSC 3 causes a paging message to be transmitted over respective paging channels of the two telecommunication access networks 6, 7.

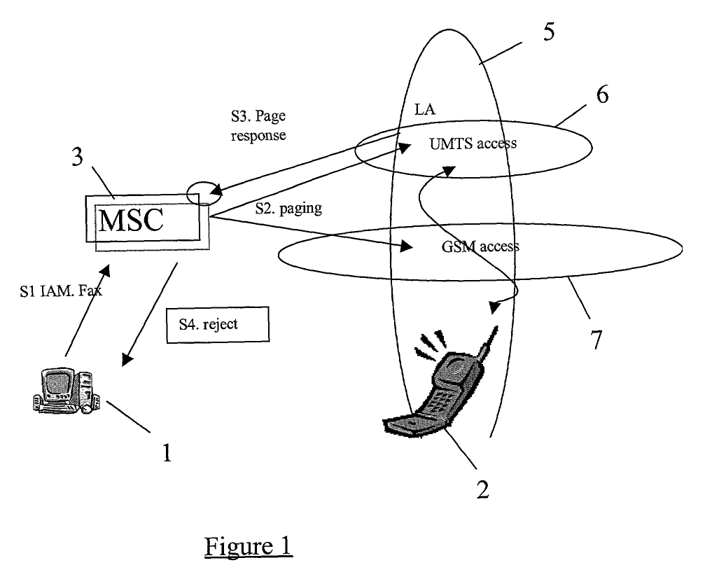

Upon receipt of the paging signal, the mobile telecommunication device 2 returns a paging response signal to the MSC, as step S22. In the example of FIG. 3, the paging response signal is returned over the UMTS access network 6. Upon receipt of the paging response signal, the MSC 3 carries out an authorisation process, which can be any conventional authorisation process. A determination is then made at the MSC 3 as to whether the mobile telecommunication access network over which the paging response was received can support the call. In the example of FIG. 3, the result of this step will be a “no” determination, since the paging response was received over the UMTS access network 6, and this cannot support a facsimile transmission. In the prior art method of FIG. 1, the call would be rejected following this “no” determination.

According to this embodiment of the invention however, the MSC 3 would send a message to the RNC in the UMTS access network 6 initiating an inter-system handover enquiry, as step S23. Upon receipt of this message, the RNC will determine whether the mobile telecommunication device 2 is in a LA that is served by another access network (the RNC does this by checking whether or not the mobile device 2 has reported cells in another access network as handover candidates). In the example of FIG. 3, this step will give a “yes” determination, since the LA 5 is also served by the GSM access network 7. This is reported to the MSC 3.

The MSC 3 then carries out a further determination, as to whether the alternative access network can support the call. In the example of FIG. 3 this step again yields a “yes” determination since the alternative network (the GSM network 7) can support a G3 facsimile call. Accordingly, the MSC notifies the RNC of the UMTS access network, and the appropriate BSC of the GSM network to perform an inter-system handover at step S24, to transfer the call from the UMTS network 6 to the GSM network 7. After the inter-system handover step, the MSC can perform a traffic channel assignment. The facsimile call is therefore set up over the GSM network, at step S25.

If on the other hand the RNC had found that handover of the call was not possible, it would report this to the MSC. This would happen if, for example, the LA 5 was not served by an alternative mobile telecommunication access network, or if the LA was served by an alternative mobile telecommunication access network but the alternative network was not able to support the call. In the case, the call would be rejected.

This embodiment of the invention is also applicable to the case where there is a pre-existing call in progress to the mobile telecommunication device 2 when the calling party 1 attempts to place the facsimile call. In this case, the paging step and the paging response step S22 would be omitted, and the MSC makes a determination about the suitability of the currently used access network immediately upon receipt of the new IAM. If the currently in use access network is determined to be unsuitable, the MSC make an inter-system handover enquiry to the BSC/RNC (step S23). If a suitable alternative network that could support the call is available, the inter-system handover occurs (step S24), the pre-existing call is transferred to the GSM network, and the G3 facsimile call is set up over the GSM access network (step S25).

In a modification to the embodiment described above, the MSC 3 may include in the message initiating inter-system handover, an authorisation to perform the handover if a GSM network (or other appropriate network) is available. There is then no need for the RNC to report back to the MSC 3 before carrying out the handover in the event that the GSM network is available.

A further embodiment of the invention relates to the suppression of undesired inter-system handover. In the situation illustrated in FIG. 2 or 3, automatic handover of a facsimile call from the GSM network 7 to the UMTS network 6 would lead to the facsimile call being terminated. In a further embodiment of the invention, therefore, the MSC informs the BSC that the facsimile call cannot be handled by the UMTS access network 6. The BSC would accordingly suppress automatic handover of the facsimile call to the UMTS access network, thereby ensuring that the facsimile call was handled by the GSM access network until the call was terminated by the calling party 1 or by the user of the mobile telecommunication device 2.

1. A method of initiating a connection to a multi-mode mobile telecommunication device, the method comprising the step of sending a paging message to the mobile telecommunication device from a core network, the paging message specifying a preferred mobile telecommunication access network for the connection.

2. A method as claimed in claim 1, and comprising returning a paging response signal from the mobile telecommunication device to the core network over the preferred mobile access network, and subsequently setting up the connection over the preferred mobile telecommunication access network.

3. A method as claimed in claim 1, and comprising returning a paging response signal from the mobile telecommunication device to the core network over a mobile access network to which the device is currently listening, and subsequently setting up the connection over the preferred mobile telecommunication access network.

4. A method according to claim 1, wherein the step of sending a paging signal to the mobile telecommunication device comprises the step of transmitting a paging signal specifying the preferred mobile telecommunication access network for the connection over each of a plurality of networks to which the device may listen.

5. A method according to claim 1, wherein the connection is one of a facsimile connection, data connection, or multi-media connection.

6. A method according to claim 1, wherein the preferred mobile telecommunication access network for the connection is one of a GSM access network and a UMTS access network.

7. A paging control system for a multi-mode mobile telecommunication device, the system comprising:
input means for receiving a connection setup message corresponding to an new connection for the multi-mode mobile telecommunication device; and
means for determining from the connection setup message whether there is a preferred mobile telecommunication access network for the connection.

8. A paging control system as claimed in claim 7 and further comprising transmission means for causing the transmission of a paging message corresponding to the connection setup message over respective paging channels of two or more mobile telecommunication access networks serving the multi-mode mobile telecommunication device, the paging message containing an indication of a preferred mobile telecommunication access network for the connection.

9. A paging control system according to claim 7 or 8, the system being located in a Mobile Switching Centre of a core network serving a plurality of access networks.

10. A Mobile Switching Centre (MSC) comprising a paging control system according to claim 7 or 8, the MSC forming part of a core network serving a plurality of access networks.

11. An MSC comprising a paging control system according to claim 8, the MSC forming part of a core network serving a plurality of access networks, wherein the MSC is arranged to initiate a handover to the preferred network when a paging response is received from a mobile telecommunication device on a non-preferred network, and the preferred network is available.

12. A Serving GPRS Support Node (SGSN) comprising a paging control system according to claim 7 or 8, the SGSN forming part of a core network serving a plurality of access networks.

13. A Serving GPRS Support Node (SGSN) comprising a paging control system according to claim 8, the SGSN forming part of a core network serving a plurality of access networks, wherein the SGSN is arranged to initiate a handover to the preferred network when a paging response is received from a mobile telecommunication device on a non-preferred network, and the preferred network is available.

14. A multi-mode mobile telecommunication device comprising:
means for receiving a paging message initiating a connection, the paging message containing an indication of a preferred mobile telecommunication access network for the connection;
means for determining the preferred mobile telecommunication access network from the paging message; and
means for transmitting a paging response signal over the preferred mobile telecommunication access network.

15. A method of setting up a connection to a multi-mode mobile telecommunication device, the method comprising the steps of:
sending a paging request from a core network to the device via at least one access network;
receiving at the core network a paging response from the device via an access network to whose paging channel(s) the device is currently listening;
determining whether that access network can support the connection; and
if it is determined that the access network to which the device is listening cannot support the connection, establishing a communication channel to the mobile telecommunication device over a second mobile access network that can support the connection.

16. A method of completing an incoming or outgoing call to a multi-mode mobile telecommunication device when a pre-existing call is connected to the mobile telecommunication device, the method comprising the step of:
determining whether the mobile telecommunication access network over which the pre-existing call is established can support the new call.

17. A method as claimed in claim 16 and further comprising the step of:
if it is determined that the mobile telecommunication access network over which the pre-existing connection is established cannot support the new connection, transferring the pre-existing connection to a second mobile telecommunication access network that can support the new connection, and establishing the new connection over the second network.

18. A method of handling a connection to a multi-mode mobile telecommunication device, the method comprising the steps of:
setting up the connection over a first mobile telecommunication access network that can support the connection;
determining whether a second mobile telecommunication access network can support the connection; and
if it is determined that the second mobile telecommunication access network cannot support the connection, inhibiting handover of the connection to the second mobile telecommunication access network.

19. A method according to claim 18, wherein said step of inhibiting a potential handover of the connection to the second mobile telecommunication access network is initiated by a MSC/SGSN, which sends a blocking signal to the RNC/BSC of the current access network.

20. A Mobile Switching Centre (MSC) for use in a mobile telecommunication network, the MSC comprising:
means for receiving a connection setup message corresponding to an new connection for a mobile wireless device;
means for determining whether a pre-existing connection is connected to the mobile device; and
means for determining, if a pre-existing connection is connected to the mobile telecommunication device, whether the mobile telecommunication access network over which the pre-existing connection is established can support the new connection.

21. An MSC as claimed in claim 20 and comprising means for transferring the pre-existing connection to another mobile telecommunication access network that can support the new connection if it is determined that the mobile telecommunication access network over which the pre-existing connection is established cannot support the new connection.

22. A Mobile Switching Centre (MSC) for use in a mobile telecommunication network, the MSC comprising:
means for setting up an new connection to a mobile telecommunication device over a first mobile telecommunication access network that can support the connection;
means for determining whether a second mobile telecommunication access network can support the connection; and
means for inhibiting hand-over of the connection to the second mobile telecommunication access network if it is determined that the second mobile telecommunication access network cannot support the connection.

23. A method of initiating a connection from a telecommunication system to one of a set of two or more communication devices, the method comprising the step of sending a paging message to at least one of the set of devices from a core network of the system, the paging message specifying a preferred mobile telecommunication access network for the connection.

24. A method of establishing a connection to a device via a specific one of a plurality of domains defined in a mobile telecommunication system, and comprising sending paging messages via one or both of the other domains, the paging messages identifying the preferred domain.
